(19) United States
(12) Patent Application Publication
(10) Pub. No.: US 2026/0075014 A1
(43) Pub. Date: Mar. 12, 2026

(54) ARTIFICIAL INTELLIGENCE-BASED SYSTEM AND METHOD FOR GENERATING AND RECOMMENDING PERSONALIZED GRAPHICS FOR MESSAGING APPLICATIONS

(71) Applicant: Microsoft Technology Licensing, LLC, Redmond, WA (US)

(72) Inventors: Shubham AGARWAL, Bengaluru (IN); Akshita JAJOO, Uttar Pradesh (IN); Rima JAIN, New Delhi (IN)

(73) Assignee: Microsoft Technology Licensing, LLC, Redmond, WA (US)

(21) Appl. No.: 18/829,495

(22) Filed: Sep. 10, 2024

(51) Int. Cl. H04L 51/10; G06T 11/60; G06V 10/70; G06V 20/40; G06V 40/16

(52) U.S. Cl. CPC H04L 51/10; G06T 11/60; G06V 10/768; G06V 20/46; G06V 40/174; G06T 2200/24; G06V 2201/10

(57) ABSTRACT

A method for generating and recommending graphics for inclusion in messages includes delivering message data to a context determining model of a graphic recommendation system, the context determining model being trained to process message data to identify context data pertaining to at least one of the message, the user, and the message partner. A prompt is generated that includes the context data and instructions for causing a model to generate one or more graphics for inclusion in the message. The graphics are delivered to a graphic recommendation model along with a plurality of predefined graphics of the messaging system to rank the graphics using at least one ranking algorithm and to select a predetermined number of graphics to include in a graphic recommendation for the message based on ranks and delivering the graphic recommendation to the messaging client.

### BACKGROUND

A messaging application is a software application designed to facilitate the sending and receiving of text messages, multimedia messages, voice notes, and other forms of communication over a network. These applications enable real-time communication between users and often include a library of graphics, such as stickers, emojis, icons, and the like, (referred to herein collectively as “message graphics” or simply “graphics”), which users can add to messages to express emotions, convey intentions, and otherwise convey a message or meaning to message recipients. Message graphics can enhance the expressiveness, engagement, empathy, understanding, personalization, localization, diversity, and inclusivity of messages and chats, and create a more engaging and interactive chat experience.

While message graphics provide many advantages and are used widely by users in messages, existing systems and methods for generating and recommending message graphics for messages have limitations and drawbacks. For example, existing systems are typically only capable of providing suggestions for graphics in response to simple keyword searches or text-to-emoticon conversions. These methods are generally not capable of capturing the nuances, subtleties, and variations of message content and context. In addition, existing recommendation systems are generally not capable of considering user characteristics, preferences, and behaviors in providing recommendations. In addition, previously known systems often have a limited selection of graphics to include in messages which may not reflect the diversity, novelty, or relevance of the message content and context.

Hence, what is needed is a system and method of generating and/or recommending graphics for messages that do not suffer from the limitations of the prior art.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions include receiving message data from a messaging client, the message data pertaining to a message between a user associated with the messaging client and a message partner; delivering the message data to a context determining model of a graphic recommendation system, the context determining model being trained to process the message data to extract context data, the context data pertaining to characteristics of the message and at least one of the user and the message partner; constructing a prompt for a graphic generating model of the graphic recommendation system, the prompt including the context data and instructions for causing the graphic generating model to generate one or more graphics for inclusion in the message; delivering the prompt as input to the graphic generating model, the graphic generating model being trained to generate the one or more graphics conditioned on the context data and the instructions; delivering the one or more graphics to a graphic recommendation model of the graphic recommendation system along with a plurality of predefined graphics of the messaging system, the graphic recommendation model being trained to rank the one or more graphics along with the plurality of predefined graphics using at least one ranking algorithm and to select a predetermined number of graphics to include in a graphic recommendation for the message based on ranks of the one or more graphics and the plurality of predefined graphics; and delivering the graphic recommendation to the messaging client for display to the user.

In yet another general aspect, the instant disclosure presents a method for generating and recommending graphics for inclusion in messages in a messaging system. The method includes receiving message data from a messaging client of the messaging system, the message data pertaining to a message between a user associated with the messaging client and a message partner; delivering the message data to a context determining model of a graphic recommendation system, the context determining model being trained to process message data to identify context data pertaining to at least one of the message, the user, and the message partner; generating a prompt for a graphic generating model of the graphic recommendation system, the prompt including the context data and instructions for causing the graphic generating model to generate one or more graphics for inclusion in the message; delivering the prompt as input to the graphic generating model, the graphic generating model being trained to generate the one or more graphics conditioned on the context data and the instructions; delivering the one or more graphics to a graphic recommendation model of the graphic recommendation system along with a plurality of predefined graphics of the messaging system, the graphic recommendation model being trained to rank the one or more graphics along with the plurality of predefined graphics using at least one ranking algorithm and to select a predetermined number of graphics to include in a graphic recommendation for the message based on ranks of the one or more graphics along and the plurality of predefined graphics; and delivering the graphic recommendation to the messaging client.

In a further general aspect, the instant application describes a non-transitory computer readable medium on which are stored instructions that when executed cause a programmable device to perform functions of receiving message data from a messaging client of a messaging system, the message data pertaining to a message between a user associated with the messaging client and a message partner; delivering the message data to a context determining model of a graphic recommendation system, the context determining model being trained to process message data to identify context data pertaining to at least one of the message, the user, and the message partner; generating a prompt for a graphic generating model of the graphic recommendation system, the prompt including the context data and instructions for causing the graphic generating model to generate one or more graphics for inclusion in the message; delivering the prompt as input to the graphic generating model, the graphic generating model being trained to generate the one or more graphics conditioned on the context data and the instructions; delivering the one or more graphics to a graphic recommendation model of the graphic recommendation system along with a plurality of predefined graphics of the messaging system, the graphic recommendation model being trained to rank the one or more graphics along with the plurality of predefined graphics using at least one ranking algorithm and to select a predetermined number of graphics to include in a graphic recommendation for the message based on ranks of the one or more graphics along and the plurality of predefined graphics; and delivering the graphic recommendation to the messaging client.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment upon which aspects of this disclosure may be implemented.

FIG. 2 depicts an example implementation of a graphic recommendation system for the messaging system of FIG. 1.

FIG. 3A depicts an example implementation of a context determining component of the graphic recommendation system of FIG. 2.

FIGS. 3B-3D show example implementations of user interfaces for a messaging application and the message graphic recommendation system for use with the messaging application.

FIGS. 3E and 3F show user interfaces of the message graphic recommendation system showing example message graphics generated for different queries.

FIGS. 4A and 4B each depict flowcharts of example methods of extracting and analyzing context data for the graphic recommendation system of FIG. 2.

FIG. 5 depicts an example implementation of a message graphic generating component of the graphic recommendation system of FIG. 2.

FIG. 6 depicts an example implementation of a message graphic recommendation component of the graphic recommendation system of FIG. 2.

FIG. 7 is a flow diagram of an example method of generating and recommending message graphics for the graphic recommendation system of FIG. 2.

FIG. 8 is a flow diagram of an example method of using feedback information to improve performance of the graphic recommendation system of FIG. 2.

FIG. 9 is a block diagram illustrating an example software architecture, various portions of which may be used in conjunction with various hardware architectures herein described.

FIG. 10 is a block diagram illustrating components of an example machine configured to read instructions from a machine-readable medium and perform any of the features described herein.

### DETAILED DESCRIPTION

Previously known messaging systems have limitations which impact their ability to provide recommendations of graphics to include in messages. For example, existing messaging systems often rely on simple keyword matching or text-to-emoticon conversion to suggest graphics to users. Keyword searches, however, do not capture the nuances, subtleties, and variations of the message content and context. For example, the same keyword or phrase used in a message may have different meanings, tones, or implications depending on the situation, emotion, or relationship between users. Moreover, users may have tendencies to use certain types of graphics or have preferences for certain styles, themes or genres. However, existing systems typically do not consider user characteristics, preferences, and behaviors in making graphics recommendations. As a result, graphics recommendations in existing systems are often irrelevant and/or unsatisfactory.

Another technical problem associated with existing messaging systems is that the existing systems and methods typically use a predefined or fixed database of graphics from which to generate and recommend graphics to users, which may not reflect the diversity, novelty, or relevance of the message content and context. For example, the predefined or fixed database of graphics may not include graphics that are related to current topics, trends, sentiments, or intents of the message, or include graphics that are relevant to the users' current location, activity, or historical or cultural background. Moreover, the system may not allow users to create, edit, or customize graphics, which limits their expressiveness, individuality, or creativity. Therefore, there exists a technical problem of the existing systems and methods not providing the most diverse, novel, or relevant graphics suggestions to the users in messages.

A further technical problem associated with existing messaging systems is that they do not identify and understand the persona of the user and message partners from the message content and context, which may affect the suitability, appropriateness, or effectiveness of recommended graphics. As used herein, the term “message partner” refers to a person that a user is sending a message to or receiving a message from via a messaging application. A message partner can be a single person or a group of people. The persona of a user and the message partner may include the role, relationship, status, or attitude of the user and the message partner, and the tone, style, or purpose of the message. The persona of the user and the message partner may influence the choice, preference, or expectation of the graphics, as well as the reaction, response, or feedback for the graphics. For example, a user may use different types of graphics when chatting with friends, family, colleagues, or strangers, and when chatting for fun, work, education, or entertainment. Therefore, there exists another technical problem of existing messaging systems not generating and/or recommending graphics that are consistent, coherent, related, and/or appropriate to the persona of the user and the message partner.

To address these technical problems and more, in an example, this description provides technical solutions in the form of a message graphic recommendation system for messaging applications capable of recommending graphics for messages that can enhance expressiveness, engagement, empathy, understanding, personalization, localization, diversity, and/or inclusivity, and generating graphics for messages that are meaningful, relevant, adaptive, responsive, informative, interesting, reflective, indicative, realistic, appealing, consistent, coherent, related, and/or appropriate to the chat content, context, and/or persona. The system is capable of extracting and analyzing various types of contextual data from messages or the video feed of users, such as keywords, sentiments, intents, preferences, gestures, movements, poses, location, activity, historical and cultural background, and social and emotional dynamics, to identify and understand the persona of the user and the message partner from the message content and context, and to generate and recommend graphics that reflect, mimic, or represent the contextual data and the persona of the user and the message partner. The system uses artificial intelligence (AI) models and a database of predefined or pre-generated graphics to generate and/or recommend graphics to include in messages. The solution is configured to rank and filter the graphics based on a relevance, novelty, diversity, and/or personalization criteria, and to present graphics recommendations to users via a user interface of the system as options which can be selected to add to messages and/or to send to other users over the Internet. The system provides a new way of enhancing the expressiveness, engagement, empathy, understanding, personalization, localization, diversity, and inclusivity of the users in messages, by creating/providing graphics such as stickers that are meaningful, relevant, adaptive, responsive, informative, interesting, reflective, indicative, realistic, appealing, consistent, coherent, related, and/or appropriate to the chat content, context, and/or persona. The technical solution generates context specific and personalized message graphics (e.g., stickers) in messaging (e.g., chat messaging). This is achieved by implementing a natural language processing (NLP) process to extract characteristics of the messages and user profiles of those involved in the message for incorporation into a generative AI prompt to generate graphics that are relevant to the message and the users. Message characteristics may include keywords of the messages, sentiment from analysis, places/dates/entity/numbers/names, classified goals/purpose, topics, and the like. User profile characteristics may include name, age, race, location, role/title/profession, gender, and the like of the users. In some implementations, prompts that include face recognition of images in the message, emotional detection from images, gestures, and the like are provided to the AI tool that generates the message graphics.

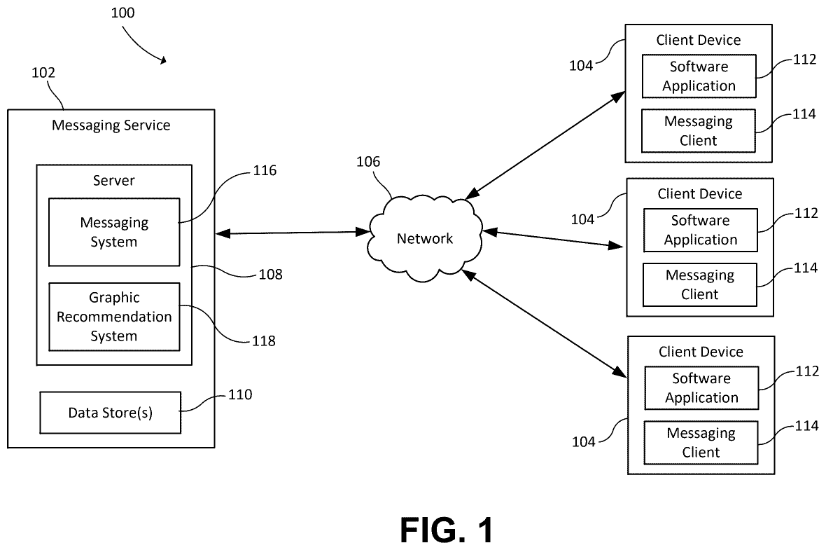

FIG. 1 illustrates an example computing environment 100 upon which aspects of the disclosure are implemented. Computing environment 100 includes a messaging service 102 and client devices 104 which communicate with each other via a network 106. The network 106 includes one or more wired, wireless, and/or a combination of wired and wireless networks. The network 106 may include one or more local area networks (LAN), wide area networks (WAN) (e.g., the Internet), public networks, private networks, virtual networks, mesh networks, peer-to-peer networks, and/or other interconnected data paths across which multiple devices may communicate. In embodiments, the network 106 is coupled to or includes portions of a telecommunications network for sending data in a variety of different communication protocols. In some implementations, the network 106 includes Bluetooth® communication networks or a cellular communications network for sending and receiving data including via short messaging service (SMS), multimedia messaging service (MMS), hypertext transfer protocol (HTTP), direct data connection, WAP, email, and the like.

The messaging service 102 is implemented as a cloud-based service or set of services. To this end, messaging service 102 includes at least one server 108 which is configured to provide computational and/or storage resources for implementing a messaging system 116 for the messaging service 102. The server 108 is representative of any physical or virtual computing system, device, or collection thereof, such as, a web server, rack server, blade server, virtual machine server, or tower server, as well as any other type of computing system. In various implementations, the server 108 is implemented in a data center, a virtual data center, or some other suitable facility. Server 108 executes one or more software applications, modules, components, or collection thereof capable of providing the messaging service to clients, such as client devices 104. In various implementations, server 108 hosts data and/or content in connection with the messaging system 116 and messaging service 102 and makes this data and/or content available to the users of client devices 104 via the network 106. Program code, instructions, user data and/or content for the messaging service 102 is stored in a data store 110. Although a single server 108 and data store 110 are shown in FIG. 1, messaging service 102 may utilize any suitable number of servers and/or data stores.

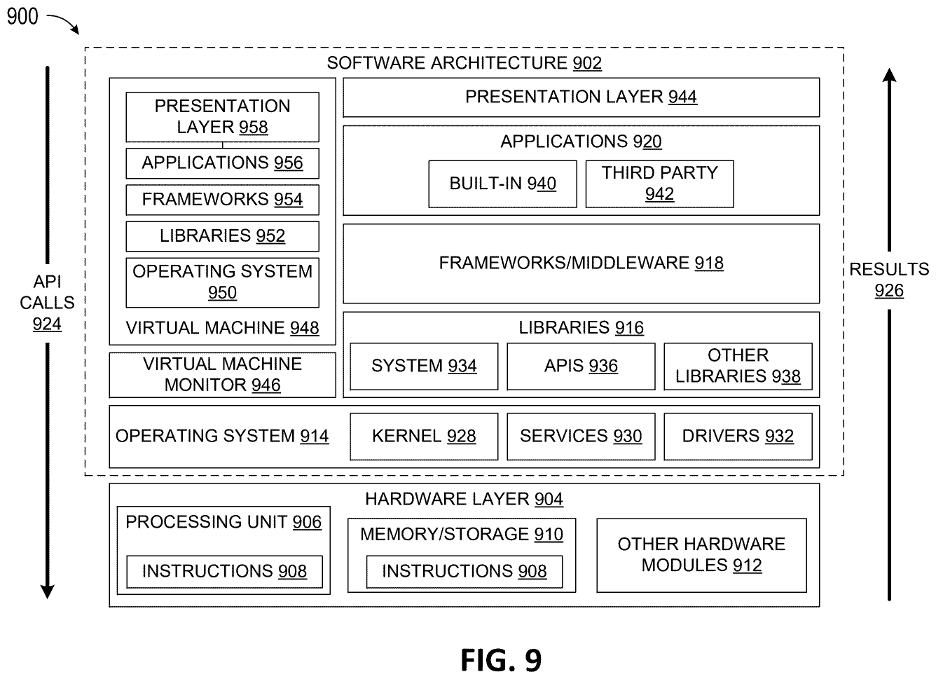

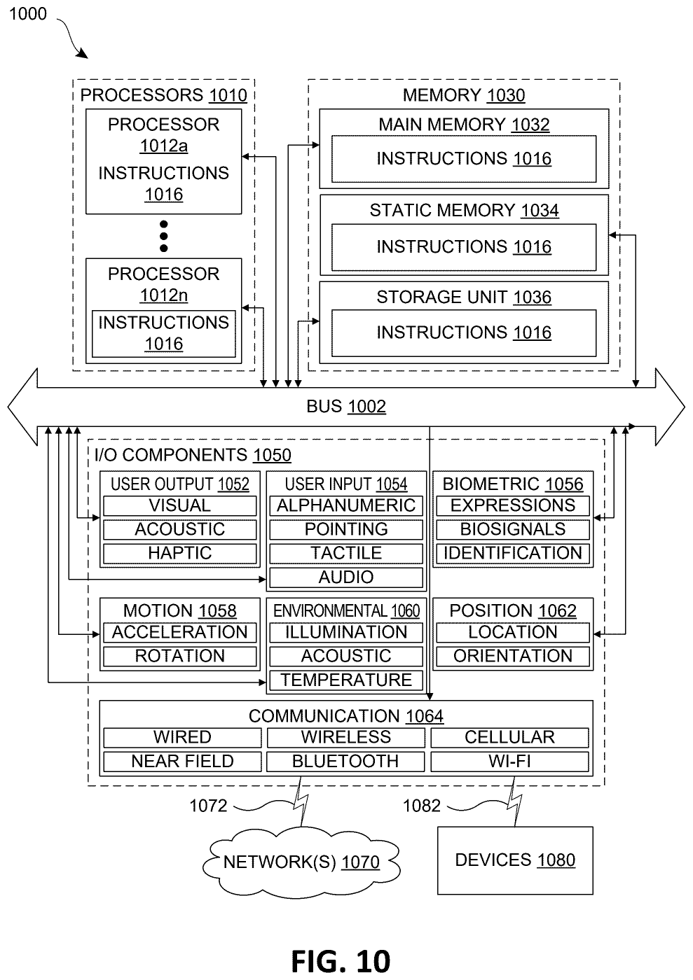

Client devices 104 enable users to access and interact with the messaging service 102. The client devices 104 may include any suitable type of computing device, such as personal computers, desktop computers, laptop computers, mobile telephones, smart phones, tablets, phablets, smart watches, wearable computers, gaming devices/computers, televisions, and the like. The internal hardware structure of a client device is discussed in greater detail with respect to FIGS. 9 and 10.

Each client device 104 includes at least one software application 112 that is executed on the client device 104. In some implementations, the software application 112 is a local application that enables users to perform one or more tasks, such as content editing, content viewing, communicating, planning, etc., at the client device. In other implementations, the software application 112 is a web browser that is capable of accessing one or more web-based applications and/or services. Each client device 104 also includes a messaging client 114 for accessing functionality provided by the messaging service 102. The messaging client 114 provides a user interface that enables users to send and receive messages over the network 106. The messaging client 114 is a software application, module, component, or collection thereof which is capable of interacting with the messaging service 102. In one implementation, the messaging client 114 is implemented as an integrated feature or component of a software application, such as software application 112. In other implementations, the messaging client 114 is implemented as a standalone software application programmed to communicate and interact with the messaging service 102.

The messaging service 102 and messaging client 114 enable users to send and receive text-based messages, multimedia messages, voice notes, and other forms of communication over the network 106. The messaging service 102 also enables users to include pre-made messaging graphics, such as stickers, emojis, icons, GIFs, and the like, in messages. Message graphics can enhance the expressiveness, engagement, empathy, understanding, personalization, localization, diversity, and inclusivity of users, and create a more fun and interactive communication experience. In previously known systems, users typically had to manually search for and select messaging graphics to include in messages. Some systems are capable of rudimentary graphic recommendations, e.g., by simple keyword matching or text-to-emoticon conversion, but these recommendations do not capture the nuances, subtleties, and variations of message content and context. Previously known graphic recommendation systems are generally not capable of considering user characteristics, preferences, and behaviors, which may affect graphic usage and selection. In addition, previously known systems typically use a predefined or fixed database of graphics that a user may utilize in messaging and from which recommendations may be made. However, the limited number of messaging graphics made available by previously known systems may not reflect the diversity, novelty, or relevance of the message content and context.

To address and overcome the technical problems and drawbacks of previously known graphic recommendation systems for messaging applications, the instant disclosure provides a message graphic recommendation system 118 capable of analyzing and utilizing various types of contextual data from the chat messages, video feeds, and the like, such as keywords, sentiments, intents, preferences, gestures, movements, poses, location, activity, historical and cultural background, and social and emotional dynamics, to identify and understand the persona of the user and the messaging partner from the message content and context, and to generate and recommend graphics that reflect, mimic, or represent the contextual data and/or the persona of the user and the messaging partner using one or more AI models, such as a generative adversarial network (GAN) or a variational autoencoder (VAE), and a database of predefined or generated graphics. The system 118 provides a new way of enhancing the expressiveness, engagement, empathy, understanding, personalization, localization, diversity, and inclusivity of the users in messages, by creating graphics that are meaningful, relevant, adaptive, responsive, informative, interesting, reflective, indicative, realistic, appealing, consistent, coherent, related, and/or appropriate to the chat content, context, and/or persona of the users involved.

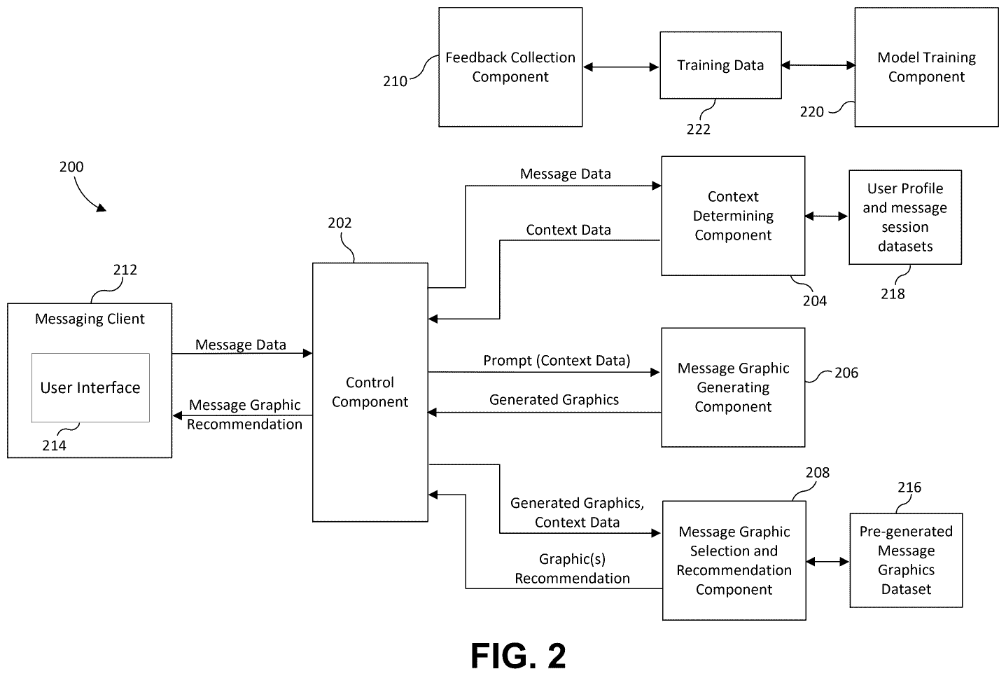

An example implementation of a message graphic recommendation system 200 is shown in FIG. 2. The system 200 includes a control component 202, a context determining component 204, a message graphic generating component 206, a message graphic recommendation component 208, and a feedback collection component 210. The control component 202 receives message data from a messaging client 212 associated with a user and coordinates the generation of a message graphic recommendation by the other components of the system. The message data includes the text and/or multimedia content of each message sent and received via the messaging client 212. Once message data for at least one message is received, the control component 202 coordinates the transfer of relevant data to and from the other components of the system to generate a recommendation of at least one message graphic to present to the user via a user interface 214 the messaging client 212. In particular, the control component 202 provides the message data to the context determining component 204 which processes the message data to determine context data pertaining to the message. The context data can include information which identifies the purpose, type, and/or function of the message, the role of the user and/or the message partner(s), the relationship between the user and the message partner(s), status of the user and message partner(s), attitude of the user and/or message partner, tone of the message, style of the message, and the like. The context data enables the persona of the user and the message partner(s) to be identified and understood.

The control component 202 receives the determined context data from the context determining component 204 and generates a prompt for the message graphic generating component 206 that includes the context data and instructions for causing the graphic generating component 206 to generate one or more graphics for inclusion in a message based on the context data. The message graphic generating component 206 utilizes AI to process the prompt and to generate the one or more graphics based on the context data. The control component 202 receives the generated graphics from the message graphic generating component 206. The control component 202 then provides the graphics to the message graphic recommendation component 208. The message graphic recommendation component 208 utilizes one or more matching, ranking, and/or filtering algorithms, models, and/or the like to select graphics to recommend to the user based on the context data for the message. The selected graphics can be selected from the graphics generated by the graphic generating component 206 and/or from a dataset of predefined graphics 216 for the messaging system. The message graphic recommendation component 208 is configured to process the graphics based on relevance, novelty, diversity, and/or personalization criteria to select a predetermined number (e.g., top k) of message graphics to select and recommend to the user. The control component 202 receives the selection of the predetermined number of message graphics and returns the recommended message graphics to the messaging client 212 as a message graphic recommendation. The messaging client 212 can then present the recommended message graphics to the user in the user interface 214 of the messaging client and enable selection and sending of recommended message graphics by the user via the user interface.

The context determining component 204 includes or has access to various datasets 218 of information pertaining to the user, such as a message transcript dataset, a video/audio feed dataset, user location (e.g., GPS location) dataset, and a user historical and cultural background dataset. The message transcript dataset can be captured by using web scraping, crawling, or API tools to collect and store the chat messages or transcripts from platforms, such as social media, messaging apps, online forums, and blogs. The datasets can include the text, metadata, and timestamp of the messages, as well as the user ID, name, and profile of the users involved in messages. The datasets can also indicate the persona of the user and the message partner(s) which have been determined based on the message content and context, such as the role, relationship, status, or attitude of the user and the chat partner, and the tone, style, or purpose of the chat. To this end, the context determining component 204 includes at least one AI model for processing the message transcripts to identify the persona of the user and message partners. The AI model can be trained to use NLP techniques, such as sentiment analysis, intent detection, topic modeling, and dialogue act classification, to analyze and interpret message transcripts.

The video/audio feed dataset can be captured by using video capture, streaming, or recording tools to collect and store the video feeds or recordings from platforms, such as video calls, live streams, or webcams. The dataset can include the video, audio, and metadata of the video feeds or recordings, as well as the user ID, name, and profile of the users involved in the video. The user location dataset can be captured by using location tracking, sensing, or reporting tools to collect and store the GPS location of the user's device, such as a smartphone, tablet, laptop, or wearable device. The dataset can include the latitude, longitude, altitude, and accuracy of the GPS location, and the user ID, name, and profile. The user historical and cultural background dataset can be captured by using survey, questionnaire, or interview tools to collect and store the information about users' historical and cultural background, and social and emotional dynamics, such as the age, gender, ethnicity, nationality, religion, language, education, occupation, relationship, mood, personality, and the like. The dataset can include the responses, answers, or inputs of the users to the survey, questionnaire, or interview, as well as the user ID, name, and profile of the users.

In collecting, storing, using and/or displaying any user data used in determining context and/or training ML models, care may be taken to comply with privacy guidelines and regulations. For example, options may be provided to seek consent (e.g., opt-in) from users for collection and use of user data, to enable users to opt-out of data collection, and/or to allow users to view and/or correct collected data.

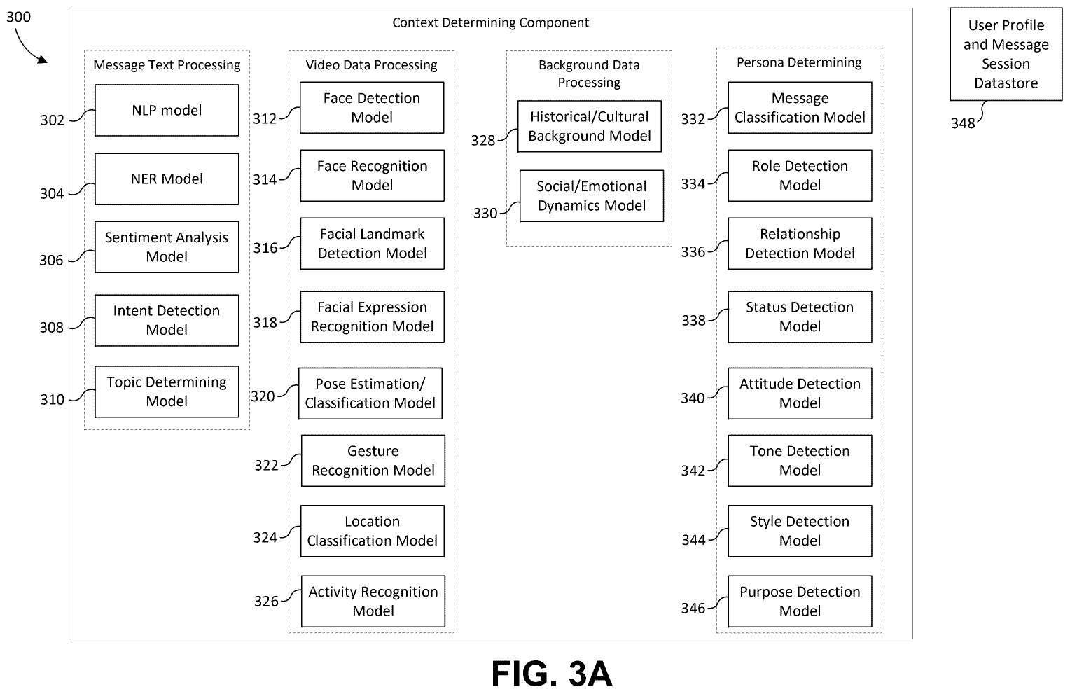

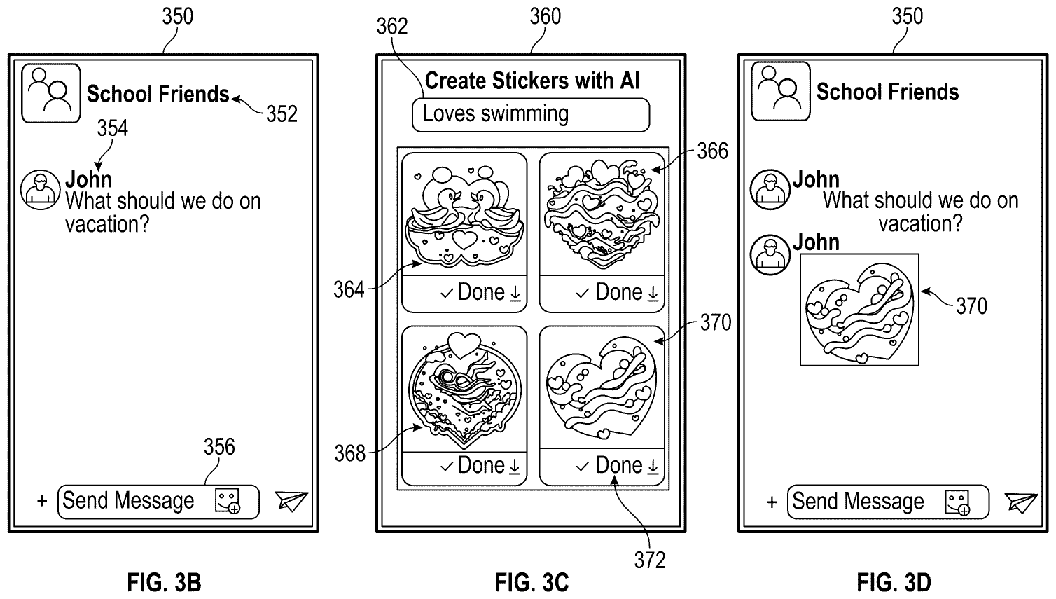

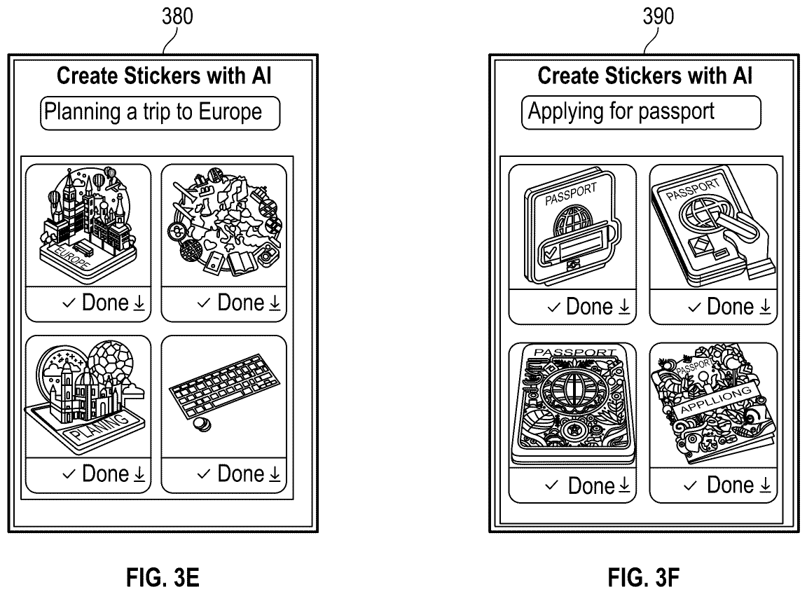

The context determining component 204 receives the message data pertaining to each message that is to be sent via the messaging client 212 and received via the messaging client 212 and determines the context of the message based on various parameters as further discussed below. An example implementation of a context determining component 300 is shown in FIG. 3A. For each message, the context determining component 300 extracts the message text, metadata, and/or timestamp of the message and adds these elements to the datasets associated with the user profile and/or the message session record. If the message includes text, the text may be provided to at least one AI language model 302, such as a Large Language Model (LLM), which is trained to use natural language processing (NLP) techniques to obtain and analyze the textual contextual data of the user, such as keywords, sentiments, intents, and/or preferences. For example, an AI language model can be used to process the input text, e.g., by tokenizing and encoding the text of the message. A named entity recognition (NER) model 304 can be used to process the encoded text in order to identify and extract any entities, such as names, places, dates, numbers, etc., from the tokens of the text of the message, and store them as keywords in a user profile and message session datastore 348. A sentiment analysis model 306 may be used to classify the tone of the emotion expressed by the text of the message, such as positive, negative, neutral, or mixed, and store them as sentiments in the datastore 348. An intent detection model 308 may be used to classify the goal or purpose of the text of the message, such as greeting, thanking, apologizing, requesting, suggesting, etc., and store them as intents in the datastore 348. A topic determining model 310 can be used to identify and extract the main topics or themes of the text of the message, such as sports, music, politics, etc., and store them as preferences in the datastore 348.

When the input is a video feed, the context determining component 300 includes one or more image models trained to utilize computer vision (CV) techniques to obtain and analyze the visual contextual data of the user, such as gestures, movements, poses, location, and activity. For example, the context determining component 300 can include a face detection model 312 to locate and crop any faces in the video feed, and a face recognition model 314 can be used to identify and match the faces in the video feed with the user ID, name, and profile of the user. A facial landmark detection model 316 can be used to locate and mark the key points of the face, such as eyes, nose, mouth, etc., in the video feed. A facial expression recognition model 318 can be used to classify the emotion expressed by the face, such as happy, sad, angry, surprised, etc., and store them as gestures. A pose estimation/classification model 320 can be used to locate and mark the key points of the body, such as head, shoulders, elbows, wrists, etc., in the video feed, and classify the posture or orientation of the body, such as standing, sitting, lying, walking, running, jumping, etc. A gesture recognition model 322 can be used to classify the action or meaning of the body, such as nodding, shaking, smiling, frowning, etc., and store them as movements or gestures. A location classification model 324 can be used to classify the type or name of the location of the user in the video feed, such as city, country, landmark, scenery, etc., and store them as locations. An activity recognition model 326 can be used to classify the type or name of the activity of the user in the video feed, such as working, studying, playing, eating, sleeping, etc. The determined gestures, movements, poses, location, and activity of the user can be stored in the user profile or the message session record in the datastore 348.

Machine learning (ML) techniques can be used to obtain and analyze the historical and cultural background, and social and emotional dynamics of the user. For example, a clustering, classification, regression, and/or neural network model 328 can be used to infer and estimate the historical and cultural background of the user from the video and metadata of the video feed, or from the user profile or other sources of information, such as age, gender, ethnicity, nationality, religion, language, education, occupation, etc., and store them as historical and cultural background. A clustering, classification, regression, and/or neural network model 330 can also be used to infer and estimate the social and emotional dynamics of the user from the video and metadata of the video feed, or from the user profile or other sources of information, such as relationship, mood, personality, etc., and store them as social and emotional dynamics.

NLP and ML techniques can be used to identify and understand the persona of the user and the message partner from the message content and context. For example, a message classification model 332 can be used to classify the type or function of the message or video feed as, for example, a statement, question, answer, command, etc. A role detection model 334 can be used to identify and extract the role of the user and the message partner, such as sender, receiver, speaker, listener, etc. A relationship detection model 336 can be used to identify and extract the relationship of the user and the message partner(s), such as friend, family, colleague, stranger, etc. A status detection model 338 can be used to identify and extract the status of the user and the message partner, such as equal, superior, inferior, etc. An attitude detection model 340 can be used to identify and extract the attitude of the user and the message partner(s) in the message, such as polite, rude, friendly, hostile, etc. A tone detection model 342 can be used to identify and extract the tone of the message or video feed, such as formal, informal, casual, serious, etc. A style detection model 344 can be used to identify and extract the style of the message or video feed, such as humorous, sarcastic, ironic, etc. A purpose detection model 346 can be used to identify and extract the purpose of the message or video feed, such as fun, work, education, entertainment, etc. The message classification, roles, relationship, status, attitude, tone, style, and purpose of the user and the message partner(s) can be stored in the user profile or the message session record.

An example implementation of a user interface for a message graphic recommendation system is shown in FIGS. 3B-3D-. FIG. 3B shows an example user interface 350 for a messaging application. The user interface 350 shows the message partner(s) 352 which in this case corresponds to “School Friends.” The user interface 350 also shows the user 354 that is sending messages to the message partner 352. In this example, the user interface 350 includes a control 356 for activating the message graphic recommendation system, e.g., by clicking on the icon with a mouse cursor. Once the control 356 has been interacted with (e.g., clicked on), a user interface 360 for the message graphic recommendation system is displayed, as shown in FIG. 3B. The user interface 360 includes a text input control 362 for receiving text which a user desires to use as the basis for generating a graphic to include in a message. In this example, the text entered into the text input control 362 is “Loves swimming.” The graphic recommendation system includes context data for the user and the message partner(s) and instructions for causing a generative AI to generate one or more graphics for inclusion in a message based on the context data. In this case, the system returns graphics 364, 366, 368, 370 which are presented in the user interface 360. The graphics are presented with controls 372 which enable selection of at least one of the graphics 364, 366, 368, 370 to include in the message. In this example, graphic 370 is selected. In response to selection of graphic 370, graphic 370 is included in a message, as shown in the user interface 350 of the messaging application, as depicted in FIG. 3C.

FIGS. 3E and 3F show examples of message graphics which can be generated by the message graphic recommendation system for different queries. In particular, FIG. 3E shows a user interface 380 for a message graphic recommendation system in which a user desires to include a message graphic pertaining to “planning a trip to Europe” in a message to a message partner. FIG. 3F shows a user interface 390 for a message graphic recommendation system in which a user desires to include a message graphic pertaining to “applying for a passport” in a message to a message partner.

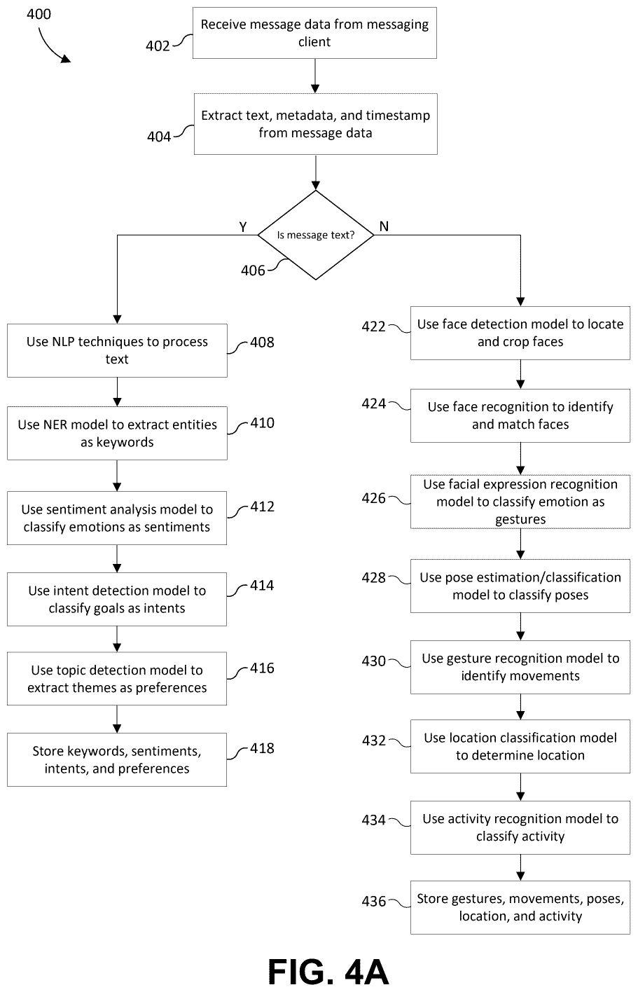

FIG. 4A depicts a flowchart of an example method 400 method for extracting context data from text-based and video-based message data. The method 400 begins with receiving message data from a message client, at 402. The text, metadata, and/or timestamp are extracted from the message data, at 404. A determination is then made as to whether the message data is text-based (as opposed to a video feed), at 406. If the message is text-based, NLP techniques are used to process the text, e.g., by tokening and encoding the text, at 408. A NER model can then be used to extract entities as keywords, at 410. A sentiment analysis model is then used to classify the emotion(s) associated with the message as sentiment(s), at 412. An intent detection model is also used to identify and classify message goals as intent(s), at 414. A topic detection model is used to extract message themes as preferences, at 416. The determined keywords, sentiments, intents, and preferences are then stored in association with the user, the message partner(s), and/or the message session, at 418.

When the message is a video feed, a face detection model is used to locate and crop faces, at 422, and a face recognition model is used to identify and match faces to user and message partner faces, at 424. A facial expression recognition model is then used to identify emotions associated with the faces and classify emotions as gestures, at 426. A pose estimation/classification model is also used to identify and classify poses of the user and message partner(s), at 428. A gesture recognition model is then used to classify the actions performed by the user in the video, such as nodding, shaking, smiling, frowning, etc., and store them as movements, at 430. A location classification model is used to process the video to determine the location of the user in the video feed, such as city, country, landmark, scenery, etc., and store this information as location data, at 432. An activity recognition model may be used to classify the type or name of activity performed by the user in the video feed, such as working, studying, playing, eating, sleeping, etc., and store this information as activity, at 434. The determined gestures, movements, poses, location, and activity are stored in association with the user, the message partner(s), and/or the message session, at 436.

FIG. 4B shows a flowchart of an example method 450 of processing message content and context to identify and understand the persona of the user and the message partner(s). The method includes using a message classification model to classify the type or function of the chat message or video feed, such as statement, question, answer, command, etc., at 452. A role detection model is used to identify and extract the role of the user and the message partner(s), such as sender, receiver, speaker, listener, etc., at 454. A relationship detection model is used to identify and extract the relationship of the user and the message partner(s), such as friend, family, colleague, stranger, etc., at 456. A status detection model is used to identify and extract the status of the user and the message partner(s), such as equal, superior, inferior, etc., at 458. An attitude detection model is used to identify and extract the attitude of the user and the message partner(s), such as polite, rude, friendly, hostile, etc., at 460. A tone detection model is used to identify and extract the tone of the message or video feed, such as formal, informal, casual, serious, etc., at 462. A style detection model is used to identify and extract the style of the message or video feed, such as humorous, sarcastic, ironic, etc., at 464. A purpose detection model is used to identify and extract the purpose of the message or video feed, such as fun, work, education, entertainment, etc., at 466. The determined message classification, roles, relationship, status, attitude, tone, style, and purpose is then stored in association with the user and the message partner(s) in the user profile or the message session record as the persona of the user and the message partner(s), at 468. The determined context data, including the persona of the user and message partner(s), is then returned, at 470.

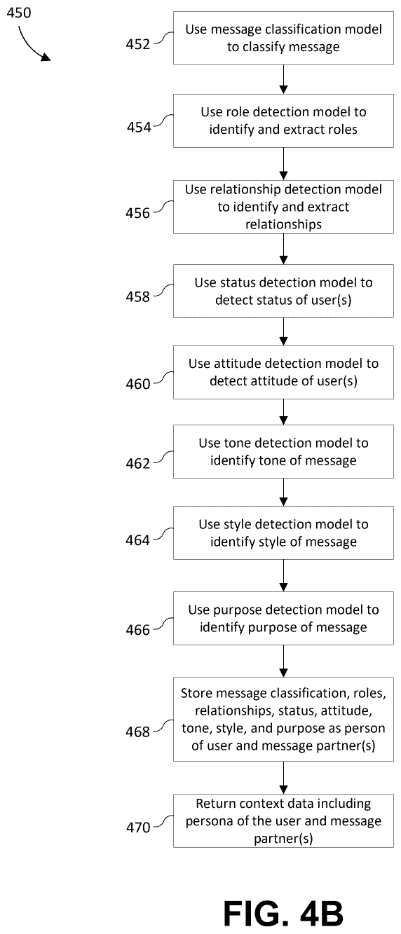

Referring to FIG. 2, the context data, such as the keywords, sentiments, intents, preferences, gestures, movements, poses, location, activity, historical and cultural background, and social and emotional dynamics, is returned to the control component 202 which in turn provides the context data to the message graphic generating component 206. An example implementation of a message graphic generating component 500 is shown in FIG. 5. The message graphic generating component 500 includes a message graphic generating model 502 which is trained to receive message and context data as input and to generate message graphics, such as stickers, emojis, icons, and other expressive images, based on the message and context data. The model 502 can use various types of data, such as image, text, audio, or animation, to generate graphics that include graphical, textual, audio, and/or animated elements. Generated graphics can use various types of features, such as shape, color, size, style, theme, or genre, to create graphics that are dynamic, complicated, exaggerated, or customized.

In various implementations, the graphic generating model may be implemented using generative AI, such as a GAN or VAE. In various implementations, the model includes a generator network to generate graphics based on context data, such as persona, message theme, and the like, or generate images from a latent space. The message graphic generating model 502 may include a discriminator network to evaluate the quality and realism of the generated graphics. The model 502 may also include a feedback loop to train and optimize the generator and discriminator networks until the generated graphics (e.g., stickers) are realistic, diverse, and relevant to the theme of the graphics and the contextual data of the users. The control component is configured to generate a prompt for the model that includes the context data and instructions for causing the graphic generating model 502 to generate one or more graphics based on the context data.

In some implementations, the message graphic generating component 500 may be configured to utilize AI to select graphics to recommend from a predefined graphic dataset which has been created for the messaging system. For example, in the implementation of FIG. 5, the component 500 includes a message graphic selection model 504 which is trained to select one or more graphics from the predefined graphic dataset to recommend to a user based on the context data. Any suitable type or combination of AI or ML model, algorithm, or engine may be utilized to select predefined graphics from the predefined graphics dataset based on context data. Graphics which have been generated based on the context data and graphics which have been selected from the predefined graphic dataset based on the context data are returned to the control component 202 which in turn provides the returned graphics to the graphic recommendation component 208. In this case, the control component may be configured to generate a prompt for causing the graphic selection model 504 to select one or more graphics based on the context data.

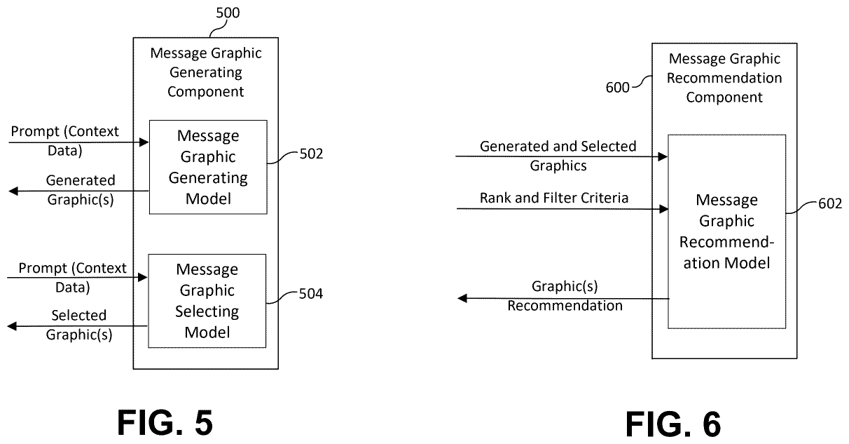

An example implementation of a message graphic recommendation component 600 is shown in FIG. 6. The graphic recommendation component 600 includes a graphic recommendation model 602 which is trained to receive message graphics as inputs and to rank and filter the graphics based on at least one criteria, such as relevance, novelty, diversity, and personalization criteria. For the relevance criterion, a similarity measure, such as cosine similarity, Jaccard similarity, edit distance, or the like is used to compare and match each graphic with the context data, and to assign a relevance score to the graphic based on the similarity score. For the novelty criterion, a novelty measure, such as inverse document frequency (IDF), inverse user frequency (IUF), or novelty detection, is used to compare and contrast each graphic with existing graphics, and to assign a novelty score to each graphic based on the novelty measure for the graphic. For the diversity criterion, a diversity measure, such as entropy, coverage, or diversity index, is used to compare and contrast each graphic with the other graphics, and to assign a diversity score to each graphic based on the diversity measure. For the personalization criterion, a personalization measure, such as user profile, user preference, or user behavior, is used to compare and match each graphic with the user profile or the message session record, and to assign a personalization score to the message based on the personalization measure. The message graphic recommendation model 602 is configured to select a predetermined number of top graphics (i.e., top k) to recommend based on the ranks/scores for the relevance, novelty, diversity, and/or personalization criteria. In various implementations, a matching algorithm may be used to rank/score a similarity of graphics to context data. A predetermined number of graphics having the highest similarity ranking/score are selected to include in a recommendation to the user along with any graphics which are selected based on the ranks/scores for the relevance, novelty, diversity, and/or personalization criteria.

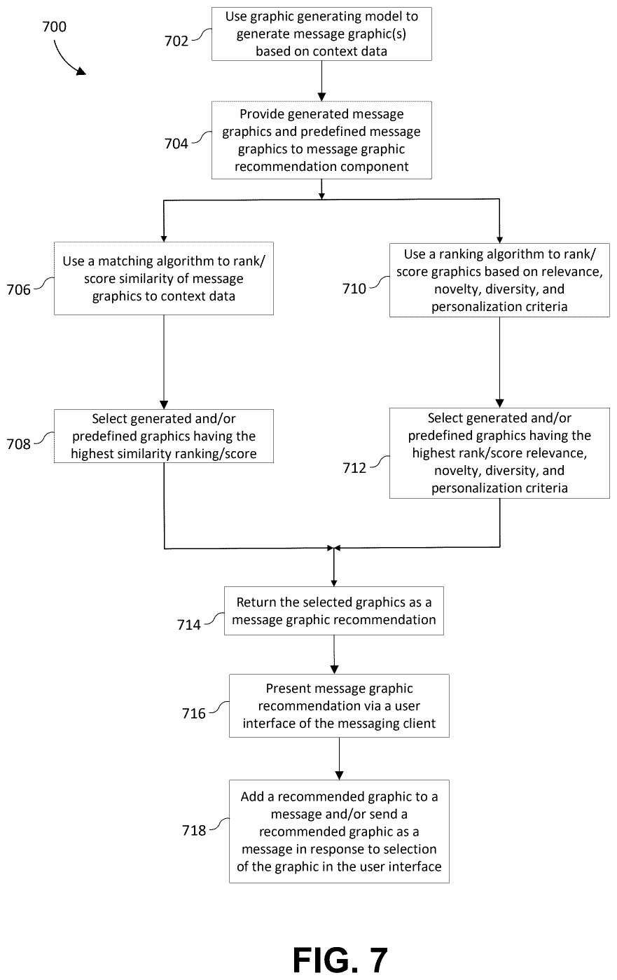

FIG. 7 depicts a flowchart of an example method 700 of generating message graphics and selecting message graphics to recommend to a user. The method 700 begins with using a graphic generating model to generate message graphics based on context data, at 702. In addition, the predefined message graphics for the messaging system are retrieved, at 704. The generated and predefined message graphics are then provided to the message graphic recommendation component, at 704. The message graphic recommendation component uses a matching algorithm and a ranking algorithm to rank/score the graphics. In an example, the message graphic recommendation component uses a matching algorithm to rank/score the similarity of the message graphics to the context data, at 706. In various implementations, the matching algorithm uses a similarity measure, such as cosine similarity, Jaccard similarity, or edit distance, to compare and match the message graphics with the context data. The generated message graphics and predefined message graphics having the highest similarity scores are selected to include in a message graphic recommendation, at 708. The message graphic recommendation component uses a ranking algorithm to rank/score the message graphics based on relevance, novelty, diversity, and/or personalization criteria, at 710. In various implementations, the ranking algorithm uses a scoring function, such as weighted sum, a linear combination, or a neural network, to score and rank message graphics based on relevance, novelty, diversity, and/or personalization criteria. The generated message graphics and predefined message graphics having the highest ranks/scores graphics based on relevance, novelty, diversity, and/or personalization criteria are selected to include in the message graphic recommendation, at 712. The graphics selected based on the matching algorithm and the ranking algorithm are returned to the messaging client as a message graphic recommendation, at 714. The message graphic recommendation is then presented to the user via a user interface of the messaging client, at 716. In response to receiving a selection of a graphic from the graphic recommendation, the selected graphic is added to a message in the messaging client and/or sent as a message via the messaging client, at 718.

Returning to FIG. 2, the feedback collection component 210 is configured to collect feedback information from users pertaining to the usage of the messaging system and the message graphic recommendation system. The feedback information can be collected in any suitable manner. For example, feedback information can be captured using feedback, rating, or review tools to collect and store the user feedback pertaining to generated and predefined graphics. Feedback information can be based on selections, rejections, ratings, comments, and/or reactions of users to the graphics. Feedback information can include the feedback information as well as other relevant information, such as names, user IDs, and profiles of users, as well as names, graphic IDs, and metadata of the graphics.

The feedback information can be used by the system to update/improve one or more components of the system, such as the message graphic generating model, the database of predefined message graphics, matching or ranking algorithms, the user profile, and the message session information. As shown in FIG. 2, the message graphic recommendation system 200 may include a model training component 220 for training one or more models of the system, such as the graphic generating model, the graphic selection model, models/algorithms for ranking/scoring graphics based on similarity or relevance, novelty, diversity, and personalization criteria. The model training component 220 utilizes training data 222 which has been derived from the feedback information collected by the feedback collection component 210. The training data 222 based on feedback information can be used to update algorithms, learn new rules, and/or reinforce learned rules. The training data 222 can also be used to optimize the relevance, novelty, diversity, and personalization criteria for generating and recommending graphics.

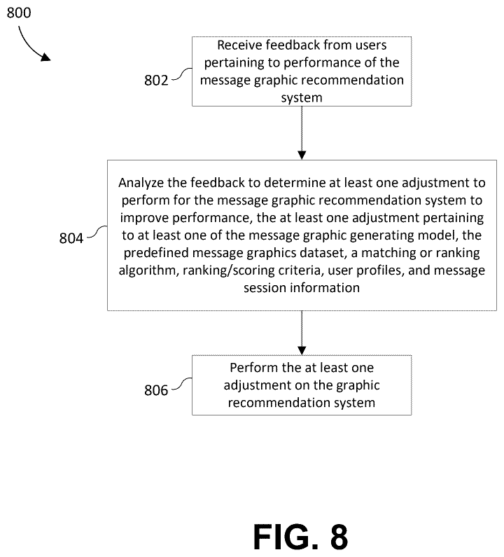

FIG. 8 depicts a flowchart of an example method 800 of adjusting a message graphic recommendation system based on feedback information. The method 800 begins with receiving feedback information pertaining to usage of the graphic recommendation system, such as selections, rejections, ratings, comments, and/or reactions of users to performance of the graphic recommendation system, at 802. The feedback information is then analyzed to determine at least one adjustment to perform for the message graphic recommendation system to improve performance, at 804. The adjustment can be to any component of the message graphic recommendation system, such as the graphic generating/selection model(s), the database of predefined message graphics, matching or ranking algorithms, ranking/scoring criteria, user profiles, and message session information. The at least one adjustment is then performed on the graphic recommendation system, at 806 to improve the system.

FIG. 9 is a block diagram 900 illustrating an example software architecture 902, various portions of which may be used in conjunction with various hardware architectures herein described, which may implement any of the above-described features. FIG. 9 is a non-limiting example of a software architecture and it will be appreciated that many other architectures may be implemented to facilitate the functionality described herein. The software architecture 902 may execute on hardware such as a machine 1000 of FIG. 10 that includes, among other things, processors 1010, memory 1030, and input/output (I/O) components 1050. A representative hardware layer 904 is illustrated and can represent, for example, the machine 1000 of FIG. 10. The representative hardware layer 904 includes a processing unit 906 and associated executable instructions 908. The executable instructions 908 represent executable instructions of the software architecture 902, including implementation of the methods, modules and so forth described herein. The hardware layer 904 also includes a memory/storage 910, which also includes the executable instructions 908 and accompanying data. The hardware layer 904 may also include other hardware modules 912. Instructions 908 held by processing unit 906 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks 918, applications 920, and a presentation layer 944. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 938 to provide many functions for applications 920 and other software modules.

The frameworks 918 (also sometimes referred to as middleware) provide a higher-level common infrastructure that may be used by the applications 920 and/or other software modules. For example, the frameworks 918 may provide various graphic user interface (GUI) functions, high-level resource management, or high-level location services. The frameworks 918 may provide a broad spectrum of other APIs for applications 920 and/or other software modules.

The applications 920 include built-in applications 940 and/or third-party applications 942. Examples of built-in applications 940 may include, but are not limited to, a contacts application, a browser application, a location application, a media application, a messaging application, and/or a game application. Third-party applications 942 may include any applications developed by an entity other than the vendor of the particular platform. The applications 920 may use functions available via OS 914, libraries 916, frameworks 918, and presentation layer 944 to create user interfaces to interact with users.

Some software architectures use virtual machines, as illustrated by a virtual machine 948. The virtual machine 948 provides an execution environment where applications/modules can execute as if they were executing on a hardware machine (such as the machine 1000 of FIG. 10, for example). The virtual machine 948 may be hosted by a host OS (for example, OS 914) or hypervisor, and may have a virtual machine monitor 946 which manages operation of the virtual machine 948 and interoperation with the host operating system. A software architecture, which may be different from software architecture 902 outside of the virtual machine, executes within the virtual machine 948 such as an operating system 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement modules or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” includes a collection of machines that individually or jointly execute the instructions 1016.

The machine 1000 may include processors 1010, memory 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multi-core processor including cores that may execute instructions contemporaneously. Although FIG. 10 shows multiple processors, the machine 1000 may include a single processor with a single core, a single processor with multiple cores (for example, a multi-core processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056, motion components 1058, environmental components 1060, and/or position components 1062, among a wide array of other physical sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1058 may include, for example, acceleration sensors (for example, an accelerometer) and rotation sensors (for example, a gyroscope). The environmental components 1060 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 1064 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1064, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for generating and recommending graphics for inclusion in messages in a messaging system, the system comprising:
a processor; and
a memory in communication with the processor, the memory comprising executable instructions that, when executed by the processor alone or in combination with other processors, cause the data processing system to perform functions of:
receiving message data from a messaging client, the message data pertaining to a message between a user associated with the messaging client and a message partner;
delivering the message data to a context determining model of a graphic recommendation system, the context determining model being trained to process the message data to extract context data, the context data pertaining to characteristics of the message and at least one of the user and the message partner;
constructing a prompt for a graphic generating model of the graphic recommendation system, the prompt including the context data and instructions for causing the graphic generating model to generate one or more graphics for inclusion in the message;
delivering the prompt as input to the graphic generating model, the graphic generating model being trained to generate the one or more graphics conditioned on the context data and the instructions;
delivering the one or more graphics to a graphic recommendation model of the graphic recommendation system along with a plurality of predefined graphics of the messaging system, the graphic recommendation model being trained to rank the one or more graphics along with the plurality of predefined graphics using at least one ranking algorithm and to select a predetermined number of graphics to include in a graphic recommendation for the message based on ranks of the one or more graphics and the plurality of predefined graphics; and
delivering the graphic recommendation to the messaging client for display to the user.

2. The data processing system of claim 1, wherein the executable instructions include instructions that, when executed, cause the data processing system to perform functions of:
displaying the graphic recommendation in a user interface of the messaging client and enabling selection of at least one graphic from the graphic recommendation via the user interface; and
in response to receiving a selection of the at least one graphic via the user interface, adding the at least one graphic to the message or sending the at least one graphic as a new message to the message partner.

3. The data processing system of claim 1, wherein:
the context determining model includes a natural language processing (NLP) model trained to process text of the message data by tokenizing and encoding the text, and
the graphic recommendation system includes a user profile dataset that includes user profile information for the user and the message partner, the user profile information being collected during previous message sessions.

4. The data processing system of claim 1, wherein:
the context determining model includes at least one artificial intelligence (AI) model trained to process the text of the message to determine at least one message characteristic of the message and at least one user characteristic pertaining to at least one of the user and the message partner, and
the context data includes the at least one message characteristic and the at least one user characteristic.

5. The data processing system of claim 3, wherein:
the at least one message characteristic includes at least one of:
keywords determined by a named entity recognition (NER) model, the NER model being trained to extract entities from the text of the message, the entities corresponding to the keywords;
sentiments determined by a sentiment analysis model, the sentiment analysis model being trained to identify and classify emotions in the text of the message, the emotions corresponding to the sentiments;
intents determined by an intent detection model, the intent detection model being trained to identify and classify goals in the text of the message, the goals corresponding to the intents; and
preferences determined by a topic detection model, the topic detection model being trained to identify topics or themes in the text of the message, the topics or themes corresponding to preferences.

6. The data processing system of claim 3, wherein:
the at least one user characteristic includes a persona of the user and the message partner, the persona including at least one of:
a message classification of the message;
roles of the user and the message partner in the message;
relationship between the user and the message partner in the message;
status of the user and the message partner in the message;
attitude of the user and the message partner in the message;
tone of the user and the message partner in the message;
style of the message; and
purpose of the message.

7. The data processing system of claim 3, wherein:
the message includes a video feed; and
the at least one user characteristic includes at least one of:
an identity of at least one of the user and the message partner in the video feed, the identity of at least one of the user and the message partner being determined using a face recognition model;
emotions of the user and message partner in the video feed, the emotions being determined by a facial expression recognition model trained to identify and classify the emotions based on facial expressions of the user and the message partner;
poses of the user and the message partner in the video feed, the poses being determined by a pose classification model trained to identify and classify body postures and orientations, the body postures and orientations corresponding to the poses;
movements of the user and message partner in the video feed, the movements being determined by a gesture recognition model trained to identify and classify actions performed by the user and the message partner, the actions corresponding to the movements;
a location of the user and the message partner in the video feed, the location being determined using a location classification model trained to identify locations based on information in video feeds; and
an activity of the user in the video feed, the activity being determined by an activity recognition model trained to identify and classify activities of people in video feeds.

8. The data processing system of claim 7, wherein:
the at least one user characteristic includes at least one of:
historical and cultural background information of the user, the historical and cultural background information including at least one an age, a gender, an ethnicity, a nationality, a religion, a language, an education, and an occupation of the user, and being determined from at least one of metadata of the message, metadata of the video feed, and previously determined user profile information; and
social and emotional dynamics of the user, the social and emotional dynamics of the user being determined from at least one of the metadata of the message, the metadata of the video feed, and the previously determined user profile information.

9. The data processing system of claim 7, wherein to construct the prompt, the executable instructions further include instructions that, when executed, cause the data processing system to perform functions of:
including at least one user characteristic in the prompt, the at least one user characteristic including at least one of:
the identity determined using the face recognition model; and
the emotions determined using the facial expression recognition model.

10. A method for generating and recommending graphics for inclusion in messages in a messaging system, the method comprising:
receiving message data from a messaging client of the messaging system, the message data pertaining to a message between a user associated with the messaging client and a message partner;
delivering the message data to a context determining model of a graphic recommendation system, the context determining model being trained to process message data to identify context data pertaining to at least one of the message, the user, and the message partner;
generating a prompt for a graphic generating model of the graphic recommendation system, the prompt including the context data and instructions for causing the graphic generating model to generate one or more graphics for inclusion in the message;
delivering the prompt as input to the graphic generating model, the graphic generating model being trained to generate the one or more graphics conditioned on the context data and the instructions;
delivering the one or more graphics to a graphic recommendation model of the graphic recommendation system along with a plurality of predefined graphics of the messaging system, the graphic recommendation model being trained to rank the one or more graphics along with the plurality of predefined graphics using at least one ranking algorithm and to select a predetermined number of graphics to include in a graphic recommendation for the message based on ranks of the one or more graphics along and the plurality of predefined graphics; and
delivering the graphic recommendation to the messaging client.

11. The method of claim 10, further comprising:
displaying the graphic recommendation in a user interface of the messaging client and enabling selection of at least one graphic from the graphic recommendation via the user interface; and
in response to receiving a selection of the at least one graphic via the user interface, adding the at least one graphic to the message or sending the at least one graphic as a new message to the message partner.

12. The method of claim 10, wherein:
the context determining model includes a natural language processing (NLP) model trained to process text of the message data by tokenizing and encoding the text, and
the graphic recommendation system includes a user profile dataset that includes user profile information for the user and the message partner, the user profile information being collected during previous message sessions.

13. The method of claim 10, wherein:
the context determining model includes at least one artificial intelligence (AI) model trained to process the text of the message to determine at least one message characteristic of the message and at least one user characteristic pertaining to the user and/or the message partner, and
the context data includes the at least one message characteristic and the at least one user characteristic.

14. The method of claim 13, wherein:
the at least one message characteristic includes at least one of:
keywords determined by a named entity recognition (NER) model, the NER model being trained to extract entities from the text of the message, the entities corresponding to the keywords;
sentiments determined by a sentiment analysis model, the sentiment analysis model being trained to identify and classify emotions in the text of the message, the emotions corresponding to the sentiments;
intents determined by an intent detection model, the intent detection model being trained to identify and classify goals in the text of the message, the goals corresponding to the intents; and
preferences determined by a topic detection model, the topic detection model being trained to identify topics or themes in the text of the message, the topics or themes corresponding to preferences.

15. The method of claim 13, wherein:
the at least one user characteristic includes a persona of the user and the message partner, the persona including at least one of:
a message classification of the message;
roles of the user and the message partner in the message;
relationship between the user and the message partner in the message;
status of the user and the message partner in the message;
attitude of the user and the message partner in the message;
tone of the user and the message partner in the message;
style of the message; and
purpose of the message.

16. The method of claim 13, wherein:
the message includes a video feed; and
the at least one user characteristic includes at least one of:
an identity of at least one of the user and the message partner in the video feed, the identity of at least one of the user and the message partner being determined using a face recognition model;
emotions of the user and message partner in the video feed, the emotions being determined by a facial expression recognition model trained to identify and classify the emotions based on facial expressions of the user and the message partner;
poses of the user and the message partner in the video feed, the poses being determined by a pose classification model trained to identify and classify body postures and orientations, the body postures and orientations corresponding to the poses;
movements of the user and message partner in the video feed, the movements being determined by a gesture recognition model trained to identify and classify actions performed by the user and the message partner, the actions corresponding to the movements;
a location of the user and the message partner in the video feed, the location being determined using a location classification model trained to identify locations based on information in video feeds; and
an activity of the user in the video feed, the activity being determined by an activity recognition model trained to identify and classify activities of people in video feeds.

17. The method of claim 16, wherein:
the at least one user characteristic includes at least one of:
historical and cultural background information of the user, the historical and cultural background information including at least one an age, a gender, an ethnicity, a nationality, a religion, a language, an education, and an occupation of the user, and being determined from at least one of metadata of the message, metadata of the video feed, and previously determined user profile information; and
social and emotional dynamics of the user, the social and emotional dynamics of the user being determined from at least one of the metadata of the message, the metadata of the video feed, and the previously determined user profile information.

18. The method of claim 10, wherein constructing the prompt further comprises:
including at least one user characteristic in the prompt, the at least one user characteristic including at least one of:
the identity of at least one of the user the message partner determined using the face recognition model; and
the emotions of the user and the message partner determined using the facial expression recognition model.

19. A non-transitory computer readable medium on which are stored instructions that, when executed, cause a programmable device to perform functions of:
receiving message data from a messaging client of a messaging system, the message data pertaining to a message between a user associated with the messaging client and a message partner;
delivering the message data to a context determining model of a graphic recommendation system, the context determining model being trained to process message data to identify context data pertaining to at least one of the message, the user, and the message partner;
generating a prompt for a graphic generating model of the graphic recommendation system, the prompt including the context data and instructions for causing the graphic generating model to generate one or more graphics for inclusion in the message;
delivering the prompt as input to the graphic generating model, the graphic generating model being trained to generate the one or more graphics conditioned on the context data and the instructions;
delivering the one or more graphics to a graphic recommendation model of the graphic recommendation system along with a plurality of predefined graphics of the messaging system, the graphic recommendation model being trained to rank the one or more graphics along with the plurality of predefined graphics using at least one ranking algorithm and to select a predetermined number of graphics to include in a graphic recommendation for the message based on ranks of the one or more graphics along and the plurality of predefined graphics; and
delivering the graphic recommendation to the messaging client.

20. The non-transitory computer readable medium of claim 19, wherein the one or more graphics include stickers.
